(19) United States
(12) Patent Application Publication
(10) Pub. No.: US 2026/0238832 A1
(43) Pub. Date: Aug. 13, 2026

(54) Signalling Of Post-Processing Filter Groups Using The SEI Processing Order SEI Message

(71) Applicant: Bytedance Inc., Los Angeles, CA (US)

(72) Inventors: Ye-Kui Wang, San Diego, CA (US); Li Zhang, San Diego, CA (US); Wei Jia, San Diego, CA (US); Jizheng Xu, San Diego, CA (US)

(21) Appl. No.: 19/640,142

(22) Filed: Apr. 6, 2026

Related U.S. Application Data
(63) Continuation of application No. PCT/US2024/049933, filed on Oct. 4, 2024.
(60) Provisional application No. 63/588,267, filed on Oct. 5, 2023.

(51) Int. Cl. H04N 19/86; H04N 19/70; H04N 19/82

(52) U.S. Cl. CPC H04N 19/86; H04N 19/70; H04N 19/82

(57) ABSTRACT

A mechanism for processing video data is disclosed. The mechanism includes determining that, except for one or more special cascading cases, any processing chain containing multiple supplemental enhancement information (SEI) message types is indicated by an SEI processing order (SPO) SEI message having a particular value of a processin order identifier syntax element. A conversion is performed between a visual media data and a bitstream based on the SPO SEI message.

### CROSS-REFERENCE TO RELATED APPLICATIONS

This patent application is a continuation of International Patent Application No. PCT/US2024/049933, filed on Oct. 4, 2024, which claims the benefit of U.S. Provisional Patent Application No. 63/588,267 filed on Oct. 5, 2023. All the aforementioned patent applications are hereby incorporated by reference in their entireties.

### TECHNICAL FIELD

The present disclosure relates to generation, storage, and consumption of digital audio video media information in a file format.

### BACKGROUND

Digital video accounts for the largest bandwidth used on the Internet and other digital communication networks. As the number of connected user devices capable of receiving and displaying video increases, the bandwidth demand for digital video usage is likely to continue to grow.

### SUMMARY

A first aspect relates to a method for processing media data, comprising: determining that, except for one or more special post-processing filter (PPF) cascading cases, any processing chain containing multiple supplemental enhancement information (SEI) message types is indicated by an SEI processing order (SPO) SEI message having a particular value of a processing order identifier syntax element; and performing a conversion between a visual media data and a bitstream based on the SPO SEI message.

Optionally, in any of the preceding aspects, another implementation of the aspect provides that the SPO SEI message indicates a preferred processing order for a group of types of SEI messages.

Optionally, in any of the preceding aspects, another implementation of the aspect provides that the preferred processing order for the group of types of SEI messages is in a list of SEI payload types.

Optionally, in any of the preceding aspects, another implementation of the aspect provides that an SEI message having the payload type in the list of SEI payload types indicates a post-processing filter (PPF).

Optionally, in any of the preceding aspects, another implementation of the aspect provides that except for one or more special PPF cascading cases any post-processing filter (PPF) not associated with an SPO SEI message is in its own processing chain.

Optionally, in any of the preceding aspects, another implementation of the aspect provides that the list of SEI payload types comprises a list of SEI payload types each implying a post-processing process.

Optionally, in any of the preceding aspects, another implementation of the aspect provides that multiple post processing filters (PPFs) are activated for at least one picture.

Optionally, in any of the preceding aspects, another implementation of the aspect provides that the multiple PPFs belong to one or more processing chains.

Optionally, in any of the preceding aspects, another implementation of the aspect provides that the one or more processing chains are alternative to each other.

Optionally, in any of the preceding aspects, another implementation of the aspect provides that at most one of the one or more processing chains is applied by a decoding apparatus at one time.

Optionally, in any of the preceding aspects, another implementation of the aspect provides that one of the special PPF cases is a special NNPF cascading case, which is defined as a case when two PPFs are both activated for a picture.

Optionally, in any of the preceding aspects, another implementation of the aspect provides that the two PPFs are both NNPFs.

Optionally, in any of the preceding aspects, another implementation of the aspect provides that one of the two NNPFs has nnpfc_purpose equal to 4 and the other has multiple input pictures.

Optionally, in any of the preceding aspects, another implementation of the aspect provides that neither of the two NNPFs is associated with the SPO SEI message.

Optionally, in any of the preceding aspects, another implementation of the aspect provides that the two NNPFs are implicitly considered as belonging to one processing chain, and wherein the NNPF with nnpfc_purpose equal to 4 is applied first.

Optionally, in any of the preceding aspects, another implementation of the aspect provides that one or more other special PPF cases are defined, and wherein the one or more special PPF cases comprise PPFs being in a single PPF processing chain or PPFs being subject to a PPF processing order.

Optionally, in any of the preceding aspects, another implementation of the aspect provides that handling of the one or more other special PPF cases is pre-defined and not indicated in the bitstream.

Optionally, in any of the preceding aspects, another implementation of the aspect provides that an order of application of PPFs in the one or more other special PPF cases is indicated in the bitstream, but the order of application of the PPFs as indicated in the bitstream is ignored and an order of application of the PPFs that was pre-defined is applied.

Optionally, in any of the preceding aspects, another implementation of the aspect provides that an order of application of PPFs in the one or more other special PPF cases is pre-defined, and wherein it is a requirement of bitstream conformance that an order indicated in the bitstream is identical to the order that was pre-defined.

Optionally, in any of the preceding aspects, another implementation of the aspect provides that except for the special NNPF cascading case, each processing chain containing multiple SEI message types is indicated by the SPO SEI message having a particular value of a processing order identifier syntax element.

Optionally, in any of the preceding aspects, another implementation of the aspect provides that for all cases, each processing chain containing multiple SEI message types is indicated by the SPO SEI message having a particular value of a processing order identifier syntax element.

Optionally, in any of the preceding aspects, another implementation of the aspect provides that the processing order identifier syntax element is designated po_id and contains an identifying number to identify the SPO SEI message.

Optionally, in any of the preceding aspects, another implementation of the aspect provides that multiple PPFs is a PPF processing chain are applied to a picture.

Optionally, in any of the preceding aspects, another implementation of the aspect provides that the multiple PPFs are applied in a cascading order.

Optionally, in any of the preceding aspects, another implementation of the aspect provides that the multiple PPFs are applied in an order indicated by the SPO SEI message associated with the PPF processing chain.

Optionally, in any of the preceding aspects, another implementation of the aspect provides that for each of the multiple PPFs that is not a last PPF applied, an output is used as an input for a next PPF applied.

Optionally, in any of the preceding aspects, another implementation of the aspect provides that for each of the multiple PPFs that is not a last PPF applied, one or more output pictures are used as one or more input pictures for a next PPF applied.

Optionally, in any of the preceding aspects, another implementation of the aspect provides that the conversion includes encoding the media data into the bitstream.

Optionally, in any of the preceding aspects, another implementation of the aspect provides that the conversion includes decoding the media data from the bitstream.

A second aspect relates to an apparatus for processing video data comprising: a processor; and a non-transitory memory with instructions thereon, wherein the instructions upon execution by the processor, cause the processor to perform the method of any of the disclosed embodiments.

A third aspect relates to a non-transitory computer readable medium comprising a computer program product for use by a video coding device, the computer program product comprising computer executable instructions stored on the non-transitory computer readable medium such that when executed by a processor cause the video coding device to perform the method of any of the disclosed embodiments.

A fourth aspect relates to a non-transitory computer-readable recording medium storing a bitstream of a video which is generated by a method performed by a video processing apparatus, wherein the method comprises: determining that, except for a special neural network post filter (NNPF) cascading case, any processing chain containing multiple supplemental enhancement information (SEI) message types is indicated by an SEI processing order (SPO) SEI message having a particular value of a processing order identifier syntax element; and performing a conversion between a visual media data and a bitstream based on the SPO SEI message.

A fifth aspect relates to a method for storing a bitstream of a video, comprising: determining that, except for a special neural network post filter (NNPF) cascading case, any processing chain containing multiple supplemental enhancement information (SEI) message types is indicated by an SEI processing order (SPO) SEI message having a particular value of a processing order identifier syntax element; generating the bitstream based on the SPO SEI message; and storing the bitstream in a non-transitory computer-readable recording medium.

A sixth aspect relates to a method, apparatus, or system described in the present disclosure.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a block diagram showing an example video processing system.

FIG. 2 is a block diagram of an example video processing apparatus.

FIG. 3 is a flowchart for an example method of video processing.

FIG. 4 is a block diagram that illustrates an example video coding system.

FIG. 5 is a block diagram that illustrates an example encoder.

FIG. 6 is a block diagram that illustrates an example decoder.

FIG. 7 is a schematic diagram of an example encoder.

### DETAILED DESCRIPTION

It should be understood at the outset that although an illustrative implementation of one or more embodiments are provided below, the disclosed systems and/or methods may be implemented using any number of techniques, whether currently known or yet to be developed. The disclosure should in no way be limited to the illustrative implementations, drawings, and techniques illustrated below, including the exemplary designs and implementations illustrated and described herein, but may be modified within the scope of the appended claims along with their full scope of equivalents.

Section headings are used in the present disclosure for ease of understanding and do not limit the applicability of techniques and embodiments disclosed in each section only to that section. Furthermore, H.266 terminology is used in some description only for ease of understanding and not for limiting scope of the disclosed techniques. As such, the techniques described herein are applicable to other video codec protocols and designs also. In the present disclosure, editing changes are shown to text by using triple brackets [[[ ]]] indicating cancelled text and double braces indicating added text, with respect to the Versatile Video Coding (VVC) specification and/or the supplemental enhancement information (SEI) messages for coded video bitstreams (VSEI) standard.

### 1. Initial Discussion

This disclosure is related to image/video coding technologies. Specifically, this disclosure is related to signalling of post-processing filter groups (e.g., processing chains) using the supplemental enhancement information (SEI) processing order SEI message. The ideas may be applied individually or in various combinations, for video bitstreams coded by any codec, e.g., the VVC standard and/or the versatile SEI messages for coded video bitstreams (VSEI) standard.

### 2. Abbreviations

Adaptation parameter set (APS), access unit (AU), coded layer video sequence (CLVS), coded layer video sequence start (CLVSS), cyclic redundancy check (CRC), coded video sequence (CVS), finite impulse response (FIR), intra random access point (IRAP), network abstraction layer (NAL), picture parameter set (PPS), picture unit (PU), random access skipped leading (RASL) picture, supplemental enhancement information (SEI), step-wise temporal sublayer access (STSA), video coding layer (VCL), versatile supplemental enhancement information as described in Rec. ITU-T H.274|ISO/IEC 23002-7 (VSEI), video usability information (VUI), versatile video coding (VVC) as described in Rec. ITU-T H.266|ISO/IEC 23090-3 (VVC).

### 3. Further Discussion

### 3.1 Video Coding Standards

Video coding standards have evolved primarily through the development of International Telecommunication Union (ITU) telecommunication standardization sector (ITU-T) and International Organization for Standardization (ISO)/International Electrotechnical Commission (IEC) standards. The ITU-T produced H.261 and H.263, ISO/IEC produced motion picture experts group (MPEG)-1 and MPEG-4 Visual, and the two organizations jointly produced the H.262/MPEG-2 Video and H.264/MPEG-4 Advanced Video Coding (AVC) and H.265/high efficiency video coding (HEVC) [1] standards. Since H.262, the video coding standards are based on the hybrid video coding structure wherein temporal prediction plus transform coding are utilized.

The Versatile Video Coding (VVC) standard (ITU-T H.266|ISO/IEC 23090-3) [2] and the associated Versatile Supplemental Enhancement Information for coded video bitstreams (VSEI) standard (ITU-T H.274|ISO/IEC 23002-7) [3] are designed for use in a maximally broad range of applications, including both the simple uses such as television broadcast, video conferencing, or playback from storage media, and also more advanced use cases such as adaptive bit rate streaming, video region extraction, composition and merging of content from multiple coded video bitstreams, multiview video, scalable layered coding, and viewport-adaptive three hundred sixty degree (360°) immersive media.

### 3.2 SEI Messages in General and in VVC

SEI messages assist in processes related to decoding, display or other purposes. However, SEI messages are not required for constructing the luma or chroma samples by the decoding process. Conforming decoders are not required to process this information for output order conformance. Some SEI messages are required for checking bitstream conformance and for output timing decoder conformance. Other SEI messages are not required for check bitstream conformance.

Annex D of VVC specifies syntax and semantics for SEI message payloads for some SEI messages, and specifies the use of the SEI messages and VUI parameters for which the syntax and semantics are specified in ITU-T H.SEI|ISO/IEC 23002-7.

### 3.3 the SEI Processing Order (SPO) SEI Message

JVET-AE2027 [4] includes the specification of an SEI message named the SEI processing order (SPO) SEI message, for carrying information indicating the preferred processing order, as determined by the encoder (the content producer), for different types of SEI messages that may be present in a coded video sequence (CVS) of the bitstream.

The specification of the SPO SEI message in JVET-AE2027 is as follows.

### 3.3.1 General SEI Payload Syntax

| | Descriptor |
|---|---|
| sei_payload( payloadType, payloadSize ) { | |
| SeiExtensionBitsPresentFlag = 0 | |
| if( nal_unit_type = = PREFIX_SEI_NUT ) | |
| if( payloadType = = 0 ) | |
| ... | |
| else if( payloadType = = 213 ) | |
| sei_processing_order( payloadSize ) | |
| ... | |
| else [[[ nal_unit_type = = SUFFIX_SEI_NUT ]]] | |
| if( payloadType = = 3 ) [[[ Specified in Rec. ITU-T H.274 \| ISO/IEC 23002-7 ]]] | |
| ... | |
| if( SeiExtensionBitsPresentFlag \| \| more_data_in_payload( ) ) { | |
| if( payload_extension_present( ) ) | |
| sei_reserved_payload_extension_data | u(v) |
| sei_payload_bit_equal_to_one [[[ equal to 1 ]]] | f(1) |
| while( !byte_aligned( ) ) | |
| sei_payload_bit_equal_to_zero [[[ equal to 0 ]]] | f(1) |
| } | |
| } | |

### 3.3.2 SEI Processing Order SEI Message Syntax

| | Descriptor |
|---|---|
| sei_processing_order( payloadSize ) { | |
| po_num_sei_messages_minus2 | u(8) |
| for( i = 0, i < po_num_sei_messages_minus2 + 2; i++) { | |
| po_sei_wrapping_flag[ i ] | u(1) |
| po_sei_importance_flag[ i ] | u(1) |
| if( po_sei_wrapping_flag[ i ] ) { | |
| reserved_alignment_6bits | u(6) |
| sei_message( ) | |
| } else { | |
| po_sei_prefix_flag[ i ] | u(1) |
| po_sei_payload_type[ i ] | u(13) |
| if( po_sei_prefix_flag[ i ]) { | |
| po_num_prefix_bytes[ i ] | b(8) |
| for( j = 0; j < po_num_prefix_bytes[ i ]; j++ ) | |
| po_prefix_byte[ i ][ j ] | b(8) |
| } | |
| } | |
| po_sei_processing_order[ i ] | u(8) |
| } | |
| } | |

### 3.3.3 SEI Processing Order SEI Message Semantics

The SEI processing order SEI message carries information indicating the preferred processing order, as determined by the encoder (i.e., the content producer), for different types of SEI messages that may be present in a CVS.

When an SEI processing order SEI message is present in any access unit of a CVS, an SEI processing order SEI message shall be present in the first access unit of the CVS. The SEI processing order SEI message persists in decoding order from the current access unit until the end of the CVS. When there are multiple SEI processing order SEI messages present in a CVS, they shall have the same content.

It is a requirement of bitstream conformance that, within an SEI processing order SEI message, there shall be at least two pairs of the syntax elements po_sei_payload_type[i] and po_sei_processing_order[i], and there shall be at least two values of po_sei_processing_order[i] that are not equal.

The SEI processing order SEI message can carry one or more SEI prefix indications of a particular payloadType. Each SEI prefix indication is a byte string that follows the SEI payload syntax of that value of payloadType and contains a number of complete syntax elements starting from the first syntax element in the SEI payload, and may be followed by bits that do not represent any complete syntax element of the SEI payload.

These SEI prefix indications should provide sufficient information to determine the specific processing order for SEI messages having the same value of payloadType but different preferred processing order.

po_num_sei_messages_minus2 plus 2 indicates the number of SEI messages that have a processing order indicated in the SEI processing order SEI message.

po_sei_importance_flag[i] indicates the degree of importance determined by the encoder for the SEI message with index i.

If the decoding system cannot interpret or does not support any indicated SEI message that has po_sei_importance_flag[i] equal to 1, it should ignore the entire SEI processing order SEI message.

reserved_alignment_6bits has no meaning and shall be equal to 0 in bitstreams conforming to this version of this Specification. Decoders shall allow this syntax element to have other values and shall ignore the value.

If po_sei_wrapping_flag[i] is equal to 0, an SEI message should be present outside of the SEI processing order SEI message with payloadType equal to po_sei_payload_type[i]. However, if po_sei_wrapping_flag[i] is equal to 0 and no SEI message is present with payloadType equal to po_sei_payload_type[i], the following applies:
If po_sei_importance_flag[i] is equal to 1, the decoder should ignore the entire SEI processing order SEI message.
Otherwise, the decoder should ignore all data associated with the loop variable value of i.

NOTE—po_sei_wrapping_flag[i] equal to 1 enables SEI messages to be carried within the SEI processing order SEI message to prevent such SEI messages from being incorrectly interpreted by decoders that do not process the SEI processing order SEI message. Thus, po_sei_wrapping_flag[i] equal to 1 is intended to be used when po_sei_wrapping_flag[i] equal to 0 can lead to unintended results being produced by such decoders.

po_sei_prefix_flag[i] equal to 1 specifies that po_num_prefix_bytes[i] is present. po_sei_prefix_flag[i] equal to 0 specifies that po_num_prefix_bytes[i] is not present.

po_sei_payload_type[i] specifies the payloadType value of the i-th SEI message type for which preferred processing order information is provided in the SEI processing order SEI message. For any two different non-negative integer values of m and n, the values of po_sei_payload_type[m] and po_sei_payload_type[n] shall not be identical unless po_sei_prefix_flag[m] and po_sei_prefix_flag[n] are both equal to 1.

SeiProcessingOrderSeiList is set to consist of the payloadType values specified in clause D.2.1, except the values 137, 144, 147, 148, 179, 180, 200, 201, 208, and 213. The value of po_sei_prefix_flag[i] shall be equal to 0 when po_sei_payload_type[i] is not equal to any value among SeiProcessingOrderSeiList.

po_num_prefix_bytes[i], when present, specifies the number of bytes associated with the i-th SEI message for which preferred processing order information is provided in the SEI processing order SEI message. When not present, the value of po_num_prefix_bytes[i] is inferred to be equal to 0.

po_prefix_byte[i][j], when present, specifies the j-th byte value of the i-th SEI message.

po_sei_processing_order[i] indicates the preferred order of processing of the i-th SEI message type for which preferred processing order information is provided in the SEI processing order SEI message. For any two different integer values of m and n that are greater than or equal to 0, po_sei_processing_order[m] less than po_sei_processing_order[n] indicates any SEI message type with payloadType equal to po_sei_payload_type[m] and, when present, bytes po_prefix_byte[m][p] for p ranging from 0 to po_num_prefix_bytes[m]−1, inclusive, should be processed before any SEI message type with payloadType equal to po_sei_payload_type[n], and, when present, bytes po_prefix_byte[n][q] for q ranging from 0 to po_num_prefix_bytes[n]−1, inclusive, and po_sei_processing_order[m] equal to po_sei_processing_order[n] indicates that there is no preferred order of processing between the SEI message types. When there are multiple SEI messages with the same values of po_sei_payload_type[i], po_num_prefix_bytes[i], and bytes po_prefix_byte[i][j] for j ranging from 0 to po_num_prefix_bytes[i]−1, inclusive, they shall have the same value of po_sei_processing_order[i].

po_sei_processing_order[0] shall be equal to 0, and for i greater than 0, po_sei_processing_order[i] shall be equal to po_sei_processing_order[i−1] or po_sei_processing_order[i−1]+1.

The value of po_sei_processing_order[po_num_sei_messages_minus2+1] shall not be equal to 0.

### 3.4 Signalling of Neural-Network Post-Filters

JVET-AE2006 [5] includes the specification of two SEI messages for signalling of neural-network post-filters, namely the neural-network post-filter characteristics (NNPFC) SEI message and the neural-network post-filter activation (NNPFA) SEI. JVET-AE2005 [6] includes the specification of the use of the NNPFC SEI message in VVC bitstreams.

The specification of NNPFC and NNPFA SEI messages in JVET-AE2006 and the specification of the use of the NNPFC SEI message in VVC bitstreams are as follows.

### 4. Technical Problems Solved by Disclosed Technical Solutions

An example design for the SEI processing order SEI message has the following problems.

First, while the SEI message types signalled in an SEI processing order (SPO) SEI message can by nature be considered as a cascading group of post-processing filters (PPFs), there lacks a mechanism to signal, using the SPO SEI message, different groups of PPFs, including but not limited to NNPFs, wherein for any particular picture only one group may be chosen to be applied while any group with active PPF(s) may be chosen.

Second, when different groups of PPFs are signalled by different SPO SEI messages, allowing them to have the same PPF, particularly the same NNPF or a PPF indicated by a colour transform information SEI message can be problematic as to which PPF group a particular PPF belongs.

Third, within a PPF group of cascading PPFs, when any PPF except for the last one would interpolate pictures when applied, the input pictures of the subsequent PPFs can be difficult.

Fourth, within a PPF group of cascading PPFs, when only the last PPF may interpolate pictures when applied, explicitly signalling of the order of the last PPF is a waste of bits.

Fifth, when present, po_num_prefix_bytes[i] equal to 0 does not make sense.

### 5. a Listing of Solutions and Embodiments

To solve the above-described problems, methods as summarized below are disclosed. The aspects should be considered as examples to explain the general concepts and should not be interpreted in a narrow way. Furthermore, these examples can be applied individually or combined in any manner.

1) To solve the first problem, one of more of the following methods are specified:
a. In one example, an identifying number, e.g., as a syntax element named po_id, is signalled in the SEI processing order SEI message to identify a group of SEI message types for which the preferred order of processing is indicated in the SEI processing order SEI message.
b. In one example, it is specified that post-processing filter (PPF) may be indicated by an SEI message for which the payloadType value is in SeiProcessingOrderSeiList.
c. In one example, it is specified that, for each picture, there can be multiple PPFs activated and belonging to one or more PPF groups. PPF groups are alternative to each other, i.e., at most one group can be chosen to be applied.
d. In one example, a special PPF cascading case is defined as the case when such two PPFs are both activated for a picture: the two PPFs are both NNPFs (i.e., the payloadType value for the NNPFs indicates the neural-network post-filter characteristics SEI message), one of the two NNPFs has nnpfc_purpose equal to 4 and the other has multiple input pictures, and neither of the two NNPFs is associated with an SEI processing order SEI message. In this case, the two NNPFs are implicitly considered as belonging to one PPF group, and the NNPF with nnpfc_purpose equal to 4 is applied first.
   i. Alternatively, other special PPF cascading cases may be defined.
   ii. In one example, how to handle those special cases (e.g., whether being in one PPF group, PPF processing order) are fixed without being indicated/signalled in the bitstream.
      1. Alternatively, how to handle those special cases may still be indicated/signalled in the bitstream, but the indicated/signalled information are ignored and the pre-defined processing method is applied.
      2. Alternatively, the order of applying PPFs in those special cases are predefined and it is a bitstream conformance requirement that the indicated order shall be identical the predefined order.
e. In one example, it is specified that, except for the special PPF cascading case, each PPF group containing multiple PPFs is associated with an SEI processing order SEI message with a particular value of a syntax element (e.g., named as po_id).
   i. Alternatively, for all cases, each PPF group containing multiple PPFs is associated with an SEI processing order SEI message with a particular value of the syntax element (e.g., the po_id).
f. In one example, it is specified that, except for the special PPF cascading case, any PPF not associated with an SEI processing order SEI message is in its own PPF group.
   i. Alternatively, for all cases, any PPF not associated with an SEI processing order SEI message is in its own PPF group.
g. In one example, it is specified that, one or more PPFs in the chosen PPF group can be applied. When multiple PPFs (in the chosen PPF group) are applied, they are applied in the cascading manner, meaning that they are applied in the order indicated by the SEI processing order SEI message associated with the chosen PPF group, and for each applied PPF that is not the last applied PPF, the output is used as the input of the next applied PPF.
   i. Alternatively, it is specified that, one or more PPFs in the chosen PPF group can be applied. When multiple PPFs (in the chosen PPF group) are applied, they are applied in the cascading manner, meaning that they are applied in the order indicated by the SEI processing order SEI message associated with the chosen PPF group, and for each applied PPF that is not the last applied PPF, the output picture(s) are used as the input picture(s) of the next applied PPF.
      2) To solve the second problem, one or more the following methods are specified:
a. In one example, it is constrained that colour transform information SEI messages associated with different SEI processing order SEI messages shall have different values of colour_transform_id.
   i. In one example, the constraint is specified as follows: For any two SEI processing order SEI messages spoSeiA and spoSeiB present in a CVS, when spoSeiA contains an entry with po_sei_payload_type[i] equal to 142 (i.e., the payloadType of the colour transform information SEI message) and spoSeiB contains an entry with po_sei_payload_type[j] equal to 142, i and j may or may not be identical, po_sei_prefix_flag[i] in spoSeiA and po_sei_prefix_flag[j] spoSeiB shall both be equal to 1, and the value of the colour_transform_id syntax element contained in the SEI prefix indication of the i-th entry in spoSeiA shall not be equal to the value of the colour_transform_id syntax element contained in the SEI prefix indication of the j-th entry in spoSeiB. The same applies when po_sei_wrapping_flag[i] in spoSeiA or po_sei_wrapping_flag[j] in spoSeiB is equal to 1, in which case the colour_transform_id syntax element is directly included in the wrapped SEI message.
b. In one example, it is constrained that neural-network post-filter characteristics SEI messages associated with different SEI processing order SEI messages shall have different values of nnpfc_id.
   i. In one example, the constraint is specified as follows: For any two SEI processing order SEI messages spoSeiA and spoSeiB present in a CVS, when spoSeiA contains an entry with po_sei_payload_type[i] equal to 210 (i.e., the payloadType of the neural-network post-filter characteristics SEI message) and spoSeiB contains an entry with po_sei_payload_type[j] equal to 210, i and j may or may not be identical, po_sei_prefix_flag[i] in spoSeiA and po_sei_prefix_flag[j] spoSeiB shall both be equal to 1, and the value of the nnpfc_id syntax element contained in the SEI prefix indication of the i-th entry in spoSeiA shall not be equal to the value of the nnpfc_id syntax element contained in the SEI prefix indication of the j-th entry in spoSeiB. The same applies when po_sei_wrapping_flag[i] in spoSeiA or po_sei_wrapping_flag[j] in spoSeiB is equal to 1, in which case the nnpfc_id syntax element is directly included in the wrapped SEI message.
c. In one example, the NNPFA SEI message is extended to be able to activate an NNPF for particular PPF group.
   i. In one example, in a kind of NNPFA SEI extension, the po_id may be signalled as well for activating the NNPF of the particular PPF group with po_id.
d. In one example, a new activation SEI message is specified for non-NN PFFs.
   i. In one example, in a kind of new activation SEI message, at least the id of the non-NN PFF may be signalled.
e. In one example, the non-PPF SEI messages themselves are extended to be able to activate a PPF for particular PPF group.
   3) To solve the 3^{rd} problem, one or more the following methods are specified:
a. In one example, it is constrained that, within an SEI processing order SEI message, at most one of the SEI message types may indicate a post-processing filter that would interopolate pictures when applied.
b. In one example, it is constrained that, within an SEI processing order SEI message, only the last SEI message type may indicate a post-processing filter that would interopolate pictures when applied.
   4) To solve the 4^{th} problem, In one example, in addition, the preferred order of processing for the PPF that would interopolate pictures when applied is not explictily signalled, but inferred to be the indicted order of the second last PPF plus one.
a. In one example, a flag e.g. named po_last_ppf_picture_interpolation_flag is added outside of the loop of “for(i=0, i<po_num_sei_messages_minus2+2; i++)”, and po_sei_processing_order[i] is conditioned on “if((i<po_num_sei_messages_minus2+1)=∥!po_last_ppf_picture_interpolation_flag)”, and the value of po_sei_processing_order[po_num_sei_messages_minus2+1] is inferred to be equal to po_sei_processing_order[po_num_sei_messages_minus2]+1.
b. In one example, the flag po_last_ppf_picture_interpolation_flag is not signalled, but a variable, e.g., named PoLastPpfPictureInterpolationFlag, is derived according to the SEI payloadType and, if present, the SEI prefix indication of the last entry, which indicates whether the last PPF would interpolate picture when applied, and po_sei_processing_order[i] is conditioned on “if((i<po_num_sei_messages_minus2+1)∥!PoLastPpfPictureInterpolationFlag)”, and the value of po_sei_processing_order[po_num_sei_messages_minus2+1] is inferred to be equal to po_sei_processing_order[po_num_sei_messages_minus2]+1.
   5) To solve the 5^{th} problem, the syntax element po_num_prefix_bytes[i] is changed to be po_num_prefix_bytes_minus1 [i], i.e. signalling the number of prefix bytes minus 1 instead of signalling the number of prefix bytes.
a. Alternativley, the syntax element po_num_prefix_bytes[i] is kept unchanged, the po_sei_prefix_flag is removed and whether prefix is available is depending on whether po_num_prefix_bytes[i] is zero.

### 6. Embodiments

Below are some example embodiments for the aspects summarized above in Section 5.

### 6.1 Embodiment 1

Most relevant parts that have been added or modified are in double braces {{ }}, and some of the deleted parts are in triple brackets [[[ ]]]. There may be some other changes that are editorial in nature and thus not indicated.

This embodiment is for the following items summarized above in Section 5: all subitems of item 1, item 5.

### D.11 SEI Processing Order SEI Message

### D.11.1 SEI Processing Order SEI Message Syntax

| | Descriptor |
|---|---|
| sei_processing_order( payloadSize ) { | |
| {{po_id | ue(v) }} |
| po_num_sei_messages_minus2 | u(8) |
| for( i = 0, i < po_num_sei_messages_minus2 + 2; i++) { | |
| po_sei_wrapping_flag[ i ] | u(1) |
| po_sei_importance_flag[ i ] | u(1) |
| if( po_sei_wrapping_flag[ i ] ) { | |
| [[[reserved_alignment_6bits | u(6) ]]] |
| {{ while( !byte_aligned( ) ) | |
| po_alignment_zero_bit | f(1) }} |
| sei_message( ) | |
| } else { | |
| po_sei_prefix_flag[ i ] | u(1) |
| po_sei_payload_type[ i ] | u(13) |
| if( po_sei_prefix_flag[ i ]) { | |
| po_num_prefix_bytes{{_minus1}}[ i ] | b(8) |
| for( j = 0; j <{{= }} po_num_prefix_bytes{{_minus1}}[ i ]; j++ ) | |
| po_prefix_byte[ i ][ j ] | b(8) |
| } | |
| } | |
| po_sei_processing_order[ i ] | u(8) |
| } | |
| } | |

### D.11.2 SEI Processing Order SEI Message Semantics

The SEI processing order SEI message carries information indicating the preferred processing order, as determined by the encoder (i.e., the content producer), for {{a group of}} different types of SEI messages that may be present in a CVS {{and that may be applied in a cascading manner.}}
{{NOTE 1—In the semantics of this SEI message, two different types of SEI messages may have the same SEI payloadType value but are differentiated by some syntax elements in the SEI payload. For example, two neural-network post-filter characteristics (NNPFC) SEI messages with different nnpfc_id values are considered as two different types of SEI messages.}}
   When an SEI processing order SEI message {{with a particular value of po_id}} is present in any access unit of a CVS, an SEI processing order SEI message {{with the particular value of po_id}} shall be present in the first access unit of the CVS. The SEI processing order SEI message persists in decoding order from the current access unit until the end of the CVS. When there are multiple SEI processing order SEI messages {{with the same value of po_id}} present in a CVS, they shall have the same content.
   It is a requirement of bitstream conformance that, within an SEI processing order SEI message, there shall be at least two pairs of the syntax elements po_sei_payload_type[i] and po_sei_processing_order[i], and there shall be at least two values of po_sei_processing_order[i] that are not equal.
   The SEI processing order SEI message can carry one or more SEI prefix indications of a particular payloadType. Each SEI prefix indication is a byte string that follows the SEI payload syntax of that value of payloadType and contains a number of complete syntax elements starting from the first syntax element in the SEI payload, and may be followed by bits that do not represent any complete syntax element of the SEI payload.
   These SEI prefix indications should provide sufficient information to determine the specific processing order for SEI messages having the same value of payloadType but different preferred processing order.
   {{po_id contains an identifying number that identifies a group of SEI message types for which the preferred order of processing is indicated in the SEI processing order SEI message. The value of po_id shall be in the range of 0 to 2³²−2, inclusive. Values of po_id from 256 to 511, inclusive, and from 2³¹ to 2³²−2, inclusive, are reserved for future use by ITU-T|ISO/IEC. Decoders conforming to this edition of this document encountering an SEI processing order SEI message with po_id in the range of 256 to 511, inclusive, or in the range of 2³¹ to 2³²−2, inclusive, shall ignore the SEI message.
   A post-processing filter (PPF) may be indicated by an SEI message for which the payloadType value is in SeiProcessingOrderSeiList, specified below.
   For each picture, there can be multiple PPFs activated and belonging to one or more PPF groups. PPF groups are alternative to each other, i.e., at most one group can be chosen to be applied.
   A special PPF cascading case is defined as the case when such two PPFs are both activated for a picture: the two PPFs are both NNPFs (i.e., the payloadType value for the NNPFs indicates the neural-network post-filter characteristics SEI message), one of the two NNPFs has nnpfc_purpose equal to 4 and the other has multiple input pictures, and neither of the two NNPFs is associated with an SEI processing order SEI message. In this case, the two NNPFs are implicitly considered as belonging to one PPF group, and the NNPF with nnpfc_purpose equal to 4 is applied first.
   Except for the special PPF cascading case, each PPF group containing multiple PPFs is associated with an SEI processing order SEI message with a particular value of po_id. Except for the special PPF cascading case, any PPF not associated with an SEI processing order SEI message is in its own PPF group.
   One or more PPFs in the chosen PPF group can be applied. When multiple PPFs (in the chosen PPF group) are applied, they are applied in the cascading manner, meaning that they are applied in the order indicated by the SEI processing order SEI message associated with the chosen PPF group, and for each applied PPF that is not the last applied PPF, the output is used as the input of the next applied PPF.}}
   po_num_sei_messages_minus2 plus 2 indicates the number of SEI messages that have a processing order indicated in the SEI processing order SEI message.
   po_sei_importance_flag[i] indicates the degree of importance determined by the encoder for the SEI message with index i.
   If the decoding system cannot interpret or does not support any indicated SEI message that has po_sei_importance_flag[i] equal to 1, it should ignore the entire SEI processing order SEI message.
   [[[reserved_alignment_6bits has no meaning and shall be equal to 0 in bitstreams conforming to this version of this Specification. Decoders shall allow this syntax element to have other values and shall ignore the value.]]]
   {{po_alignment_zero_bit shall be equal to 0.}}
   If po_sei_wrapping_flag[i] is equal to 0, an SEI message should be present outside of the SEI processing order SEI message with payloadType equal to po_sei_payload_type[i]. However, if po_sei_wrapping_flag[i] is equal to 0 and no SEI message is present with payloadType equal to po_sei_payload_type[i], the following applies:
If po_sei_importance_flag[i] is equal to 1, the decoder should ignore the entire SEI processing order SEI message.
Otherwise, the decoder should ignore all data associated with the loop variable value of i.
NOTE 2—po_sei_wrapping_flag[i] equal to 1 enables SEI messages to be carried within the SEI processing order SEI message to prevent such SEI messages from being incorrectly interpreted by decoders that do not process the SEI processing order SEI message. Thus, po_sei_wrapping_flag[i] equal to 1 is intended to be used when po_sei_wrapping_flag[i] equal to 0 can lead to unintended results being produced by such decoders.
   po_sei_prefix_flag[i] equal to 1 specifies that po_num_prefix_bytes[i] is present. po_sei_prefix_flag[i] equal to 0 specifies that po_num_prefix_bytes[i] is not present.
   po_sei_payload_type[i] specifies the payloadType value of the i-th SEI message type for which preferred processing order information is provided in the SEI processing order SEI message. For any two different non-negative integer values of m and n, the values of po_sei_payload_type[m] and po_sei_payload_type[n] shall not be identical unless po_sei_prefix_flag[m] and po_sei_prefix_flag[n] are both equal to 1.
   SeiProcessingOrderSeiList is set to consist of the payloadType values specified in clause D.2.1, except the values 137, 144, 147, 148, 179, 180, 200, 201, 208, and 213. The value of po_sei_prefix_flag[i] shall be equal to 0 when po_sei_payload_type[i] is not equal to any value among SeiProcessingOrderSeiList.
   [[[po_num_prefix_bytes[i], when present, specifies the number of bytes associated with the i-th SEI message for which preferred processing order information is provided in the SEI processing order SEI message. When not present, the value of po_num_prefix_bytes[i] is inferred to be equal to 0.]]]
   {{When present, po_num_prefix_bytes_minus1[i] plus 1 specifies the number of bytes associated with the i-th SEI message for which preferred processing order information is provided in the SEI processing order SEI message.}}
   po_prefix_byte[i][j], when present, specifies the j-th byte value of the i-th SEI message.
   po_sei_processing_order[i] indicates the preferred order of processing of the i-th SEI message type for which preferred processing order information is provided in the SEI processing order SEI message. For any two different integer values of m and n that are greater than or equal to 0, po_sei_processing_order[m] less than po_sei_processing_order[n] indicates any SEI message type with payloadType equal to po_sei_payload_type[m] and, when present, bytes po_prefix_byte[m][p] for p ranging from 0 to po_num_prefix_bytes[m]−1, inclusive, should be processed before any SEI message type with payloadType equal to po_sei_payload_type[n], and, when present, bytes po_prefix_byte[n][q] for q ranging from 0 to po_num_prefix_bytes[n]−1, inclusive, and po_sei_processing_order[m] equal to po_sei_processing_order[n] indicates that there is no preferred order of processing between the SEI message types. When there are multiple SEI messages with the same values of po_sei_payload_type[i], po_num_prefix_bytes[i], and bytes po_prefix_byte[i][j] for j ranging from 0 to po_num_prefix_bytes[i]−1, inclusive, they shall have the same value of po_sei_processing_order[i].
   po_sei_processing_order[0] shall be equal to 0, and for i greater than 0, po_sei_processing_order[i] shall be equal to po_sei_processing_order[i−1] or po_sei_processing_order[i−1]+1.
   The value of po_sei_processing_order[po_num_sei_messages_minus2+1] shall not be equal to 0.

### 6.2 Embodiment 2

This embodiment is for the items 1 to 4 summarized above in Section 5. The changes are marked relative to embodiment 1. On top of embodiment 1, this embodiment is for the following items summarized above in Section 5:3.b, 4, 4.a.

### D.11 SEI Processing Order SEI Message

### D.11.1 SEI Processing Order SEI Message Syntax

| | Descriptor |
|---|---|
| sei_processing_order( payloadSize ) { | |
| po_id | ue(v) |
| po_num_sei_messages_minus2 | u(8) |
| {{po_last_ppf_picture_interpolation_flag | u(1)}} |
| for( i = 0, i < po_num_sei_messages_minus2 + 2; i++) { | |
| po_sei_wrapping_flag[ i ] | u(1) |
| po_sei_importance_flag[ i ] | u(1) |
| if( po_sei_wrapping_flag[ i ] ) { | |
| while( !byte_aligned( ) ) | |
| po_alignment_zero_bit | f(1) |
| sei_message( ) | |
| } else { | |
| po_sei_prefix_flag[ i ] | u(1) |
| po_sei_payload_type[ i ] | u(13) |
| if( po_sei_prefix_flag[ i ]) { | |
| po_num_prefix_bytes_minus1[ i ] | b(8) |
| for( j = 0; j <= po_num_prefix_bytes_minus1[ i ]; j++ ) | |
| po_prefix_byte[ i ][ j ] | b(8) |
| } | |
| } | |
| {{if( ( i < po_num_sei_messages_minus2 + 1 ) \| \| | |
| !po_last_ppf_picture_interpolation_flag ) )}} | |
| po_sei_processing_order[ i ] | u(8) |
| } | |
| } | |

### D.11.2 SEI Processing Order SEI Message Semantics

The SEI processing order SEI message carries information indicating the preferred processing order, as determined by the encoder (i.e., the content producer), for a group of different types of SEI messages that may be present in a CVS and that may be applied in a cascading manner.
NOTE 1—In the semantics of this SEI message, two different types of SEI messages may have the same SEI payloadType value but are differentiated by some syntax elements in the SEI payload. For example, two neural-network post-filter characteristics (NNPFC) SEI messages with different nnpfc_id values are considered as two different types of SEI messages.
   When an SEI processing order SEI message with a particular value of po_id is present in any access unit of a CVS, an SEI processing order SEI message with the particular value of po_id shall be present in the first access unit of the CVS. The SEI processing order SEI message persists in decoding order from the current access unit until the end of the CVS. When there are multiple SEI processing order SEI messages with the same value of po_id present in a CVS, they shall have the same content.
   {{It is a requirement of bitstream conformance that, within an SEI processing order SEI message, among all the different SEI message types for which the preferred order of processing is indicated, the SEI message types that are not the last SEI message type shall not indicate a post-processing filter that would interpolate pictures when applied. Alternative to the above constraint, the following constraint is specified: It is a requirement of bitstream conformance that, within an SEI processing order SEI message, among all the different SEI message types for which the preferred order of processing is indicated, there shall not be more than SEI message type that indicates a post-processing filter that would interoplate pictures when applied.}}
   It is a requirement of bitstream conformance that, within an SEI processing order SEI message, there shall be at least two pairs of the syntax elements po_sei_payload_type[i] and po_sei_processing_order[i], and there shall be at least two values of po_sei_processing_order[i] that are not equal.
   The SEI processing order SEI message can carry one or more SEI prefix indications of a particular payloadType. Each SEI prefix indication is a byte string that follows the SEI payload syntax of that value of payloadType and contains a number of complete syntax elements starting from the first syntax element in the SEI payload, and may be followed by bits that do not represent any complete syntax element of the SEI payload.
   These SEI prefix indications should provide sufficient information to determine the specific processing order for SEI messages having the same value of payloadType but different preferred processing order.
   po_id contains an identifying number that identifies a group of SEI message types for which the preferred order of processing is indicated in the SEI processing order SEI message. The value of po_id shall be in the range of 0 to 2³²−2, inclusive. Values of po_id from 256 to 511, inclusive, and from 2³¹ to 2³²−2, inclusive, are reserved for future use by ITU-T|ISO/IEC. Decoders conforming to this edition of this document encountering an SEI processing order SEI message with po_id in the range of 256 to 511, inclusive, or in the range of 2³¹ to 2³²−2, inclusive, shall ignore the SEI message.
   A post-processing filter (PPF) may be indicated by an SEI message for which the payloadType value is in SeiProcessingOrderSeiList, specified below.
   For each picture, there can be multiple PPFs activated and belonging to one or more PPF groups. PPF groups are alternative to each other, i.e., at most one group can be chosen to be applied.
   A special PPF cascading case is defined as the case when such two PPFs are both activated for a picture: the two PPFs are both NNPFs (i.e., the payloadType value for the NNPFs indicates the neural-network post-filter characteristics SEI message), one of the two NNPFs has nnpfc_purpose equal to 4 and the other has multiple input pictures, and neither of the two NNPFs is associated with an SEI processing order SEI message. In this case, the two NNPFs are implicitly considered as belonging to one PPF group, and the NNPF with nnpfc_purpose equal to 4 is applied first.
   Except for the special PPF cascading case, each PPF group containing multiple PPFs is associated with an SEI processing order SEI message with a particular value of po_id. Except for the special PPF cascading case, any PPF not associated with an SEI processing order SEI message is in its own PPF group.
   One or more PPFs in the chosen PPF group can be applied. When multiple PPFs (in the chosen PPF group) are applied, they are applied in the cascading manner, meaning that they are applied in the order indicated by the SEI processing order SEI message associated with the chosen PPF group, and for each applied PPF that is not the last applied PPF, the output is used as the input of the next applied PPF.
   po_num_sei_messages_minus2 plus 2 indicates the number of SEI messages that have a processing order indicated in the SEI processing order SEI message.
   {{po_last_ppf_picture_interpolation_flag equal to 1 indicates that the last SEI message type in this SEI message indicates a PFF that would interpolate pictures when applied. po_last_ppf_picture_interpolation_flag equal to 0 indicates that the last SEI message type in this SEI message indicates a PFF that would not interpolate pictures when applied.}}
   If the decoding system cannot interpret or does not support any indicated SEI message that has po_sei_importance_flag[i] equal to 1, it should ignore the entire SEI processing order SEI message.
   po_alignment_zero_bit shall be equal to 0.
   If po_sei_wrapping_flag[i] is equal to 0, an SEI message should be present outside of the SEI processing order SEI message with payloadType equal to po_sei_payload_type[i]. However, if po_sei_wrapping_flag[i] is equal to 0 and no SEI message is present with payloadType equal to po_sei_payload_type[i], the following applies:
If po_sei_importance_flag[i] is equal to 1, the decoder should ignore the entire SEI processing order SEI message.
Otherwise, the decoder should ignore all data associated with the loop variable value of i.
NOTE 2—po_sei_wrapping_flag[i] equal to 1 enables SEI messages to be carried within the SEI processing order SEI message to prevent such SEI messages from being incorrectly interpreted by decoders that do not process the SEI processing order SEI message. Thus, po_sei_wrapping_flag[i] equal to 1 is intended to be used when po_sei_wrapping_flag[i] equal to 0 can lead to unintended results being produced by such decoders.
   po_sei_prefix_flag[i] equal to 1 specifies that po_num_prefix_bytes[i] is present. po_sei_prefix_flag[i] equal to 0 specifies that po_num_prefix_bytes[i] is not present.
   po_sei_payload_type[i] specifies the payloadType value of the i-th SEI message type for which preferred processing order information is provided in the SEI processing order SEI message. For any two different non-negative integer values of m and n, the values of po_sei_payload_type[m] and po_sei_payload_type[n] shall not be identical unless po_sei_prefix_flag[m] and po_sei_prefix_flag[n] are both equal to 1.
   SeiProcessingOrderSeiList is set to consist of the payloadType values specified in clause D.2.1, except the values 137, 144, 147, 148, 179, 180, 200, 201, 208, and 213. The value of po_sei_prefix_flag[i] shall be equal to 0 when po_sei_payload_type[i] is not equal to any value among SeiProcessingOrderSeiList.
   When present, po_num_prefix_bytes_minus1[i] plus 1 specifies the number of bytes associated with the i-th SEI message for which preferred processing order information is provided in the SEI processing order SEI message.
   po_prefix_byte[i][j], when present, specifies the j-th byte value of the i-th SEI message.
   po_sei_processing_order[i] indicates the preferred order of processing of the i-th SEI message type for which preferred processing order information is provided in the SEI processing order SEI message. For any two different integer values of m and n that are greater than or equal to 0, po_sei_processing_order[m] less than po_sei_processing_order[n] indicates any SEI message type with payloadType equal to po_sei_payload_type[m] and, when present, bytes po_prefix_byte[m][p] for p ranging from 0 to po_num_prefix_bytes[m]−1, inclusive, should be processed before any SEI message type with payloadType equal to po_sei_payload_type[n], and, when present, bytes po_prefix_byte[n][q] for q ranging from 0 to po_num_prefix_bytes[n]−1, inclusive, and po_sei_processing_order[m] equal to po_sei_processing_order[n] indicates that there is no preferred order of processing between the SEI message types. When there are multiple SEI messages with the same values of po_sei_payload_type[i], po_num_prefix_bytes[i], and bytes po_prefix_byte[i][j] for j ranging from 0 to po_num_prefix_bytes[i]−1, inclusive, they shall have the same value of po_sei_processing_order[i].
   {{When po_last_ppf_picture_interpolation_flag is equal to 1, the value of po_sei_processing_order[po_num_sei_messages_minus2+1] is inferred to be equal to po_sei_processing_order[po_num_sei_messages_minus2]+1.}}
   po_sei_processing_order[0] shall be equal to 0, and for i greater than 0, po_sei_processing_order[i] shall be equal to po_sei_processing_order[i−1] or po_sei_processing_order[i−1]+1.
   The value of po_sei_processing_order[po_num_sei_messages_minus2+1] shall not be equal to 0.

### 7. REFERENCES

[1] ITU-T and ISO/IEC, “High efficiency video coding”, Rec. ITU-T H.265|ISO/IEC 23008-2 (in force edition).
[2] ITU-T and ISO/IEC, “Versatile Video Coding”, Rec. ITU-T H.266|ISO/IEC 23090-3.
[3] ITU-T and ISO/IEC, “Versatile Supplemental Enhancement Information Messages for Coded Video Bitstreams”, Rec. ITU-T Rec. H.274|ISO/IEC 23002-7.
[4] S. McCarthy, M. M. Hannuksela, and Y.-K. Wang (eds), JVET-AE2027, “SEI processing order SEI message in VVC (draft 5)”.
[5] S. McCarthy, T. Chujoh, M. Hannuksela, G. J. Sullivan, and Y.-K. Wang (editors), “Additional SEI messages for VSEI (Draft 5)”, JVET output document JVET-AE2006, publicly available online herein: https://jvet-experts.org/doc_end_user/current_document.php?id=13271.
[6] B. Bross, E. François, M. M. Hannuksela, A. Tourapis, and Y.-K. Wang (editors), “New level and systems-related supplemental enhancement information for VVC (Draft 6)”, JVET output document JVET-AE2005, publicly available online herein: https://jvet-experts.org/doc_end_user/current_document.php?id=13270.

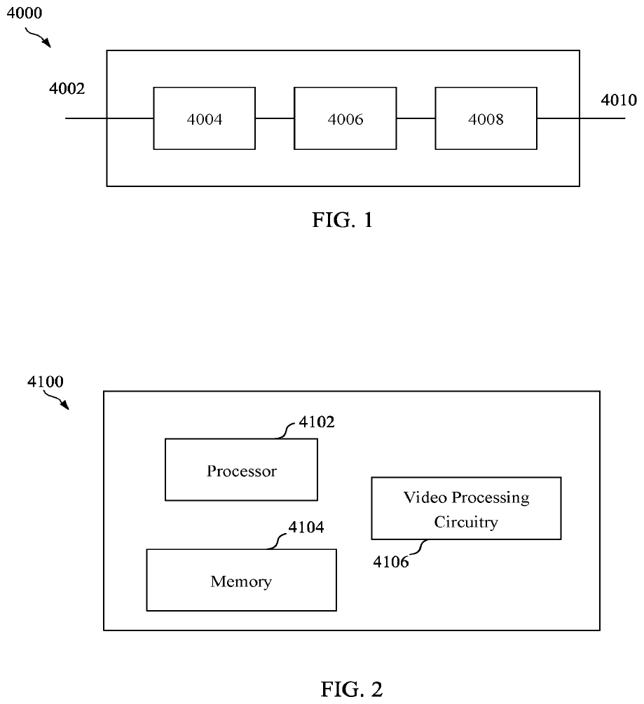

FIG. 1 is a block diagram showing an example video processing system 4000 in which various techniques disclosed herein may be implemented. Various implementations may include some or all of the components of the system 4000. The system 4000 may include input 4002 for receiving video content. The video content may be received in a raw or uncompressed format, e.g., 8 or 10 bit multi-component pixel values, or may be in a compressed or encoded format. The input 4002 may represent a network interface, a peripheral bus interface, or a storage interface. Examples of network interface include wired interfaces such as Ethernet, passive optical network (PON), etc. and wireless interfaces such as wireless fidelity (Wi-Fi) or cellular interfaces.

The system 4000 may include a coding component 4004 that may implement the various coding or encoding methods described in the present disclosure. The coding component 4004 may reduce the average bitrate of video from the input 4002 to the output of the coding component 4004 to produce a coded representation of the video. The coding techniques are therefore sometimes called video compression or video transcoding techniques. The output of the coding component 4004 may be either stored, or transmitted via a communication connected, as represented by the component 4006. The stored or communicated bitstream (or coded) representation of the video received at the input 4002 may be used by a component 4008 for generating pixel values or displayable video that is sent to a display interface 4010. The process of generating user-viewable video from the bitstream representation is sometimes called video decompression. Furthermore, while certain video processing operations are referred to as “coding” operations or tools, it will be appreciated that the coding tools or operations are used at an encoder and corresponding decoding tools or operations that reverse the results of the coding will be performed by a decoder.

Examples of a peripheral bus interface or a display interface may include universal serial bus (USB) or high definition multimedia interface (HDMI) or Displayport, and so on. Examples of storage interfaces include serial advanced technology attachment (SATA), peripheral component interconnect (PCI), integrated drive electronics (IDE) interface, and the like. The techniques described in the present disclosure may be embodied in various electronic devices such as mobile phones, laptops, smartphones or other devices that are capable of performing digital data processing and/or video display.

FIG. 2 is a block diagram of an example video processing apparatus 4100. The apparatus 4100 may be used to implement one or more of the methods described herein. The apparatus 4100 may be embodied in a smartphone, tablet, computer, Internet of Things (IoT) receiver, and so on. The apparatus 4100 may include one or more processors 4102, one or more memories 4104 and video processing circuitry 4106. The processor(s) 4102 may be configured to implement one or more methods described in the present disclosure. The memory (memories) 4104 may be used for storing data and code used for implementing the methods and techniques described herein. The video processing circuitry 4106 may be used to implement, in hardware circuitry, some techniques described in the present disclosure. In some embodiments, the video processing circuitry 4106 may be at least partly included in the processor 4102, e.g., a graphics co-processor.

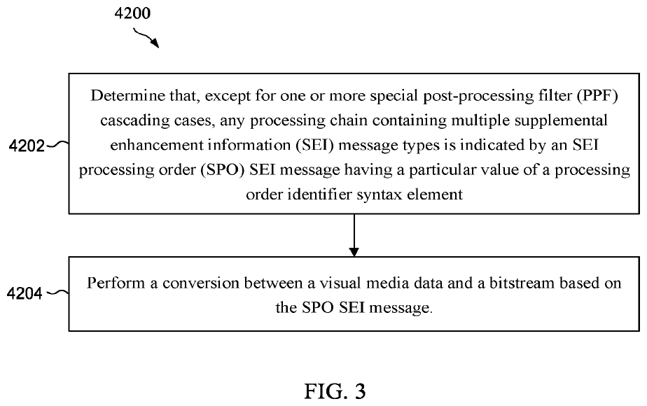

FIG. 3 is a flowchart for an example method 4200 of video processing. The method 4200 determines that, except for one or more special post-processing filter (PPF) cascading cases, any processing chain containing multiple supplemental enhancement information (SEI) message types is indicated by an SEI processing order (SPO) SEI message having a particular value of a processing order identifier syntax element, at step 4202. In an embodiment, the SPO SEI message indicates a preferred processing order for a group of types of SEI messages. In an embodiment, the preferred processing order for the group of types of SEI messages is in a list of SEI payload types. In an embodiment, an SEI message having the payload type in the list of SEI payload types indicates a post-processing filter (PPF). In an embodiment, except for one or more special PPF cascading cases any post-processing filter (PPF) not associated with an SPO SEI message is in its own processing chain. In an embodiment, the list of SEI payload types comprises a list of SEI payload types each implying a post-processing process. A conversion between a visual media data and a bitstream is perfomed based on the SEI message, at step 4204. The conversion may include encoding at an encoder, decoding at a decoder, or combinations thereof.

It should be noted that the method 4200 can be implemented in an apparatus for processing video data comprising a processor and a non-transitory memory with instructions thereon, such as video encoder 4400, video decoder 4500, and/or encoder 4600. In such a case, the instructions upon execution by the processor, cause the processor to perform the method 4200. Further, the method 4200 can be performed by a non-transitory computer readable medium comprising a computer program product for use by a video coding device. The computer program product comprises computer executable instructions stored on the non-transitory computer readable medium such that when executed by a processor cause the video coding device to perform the method 4200.

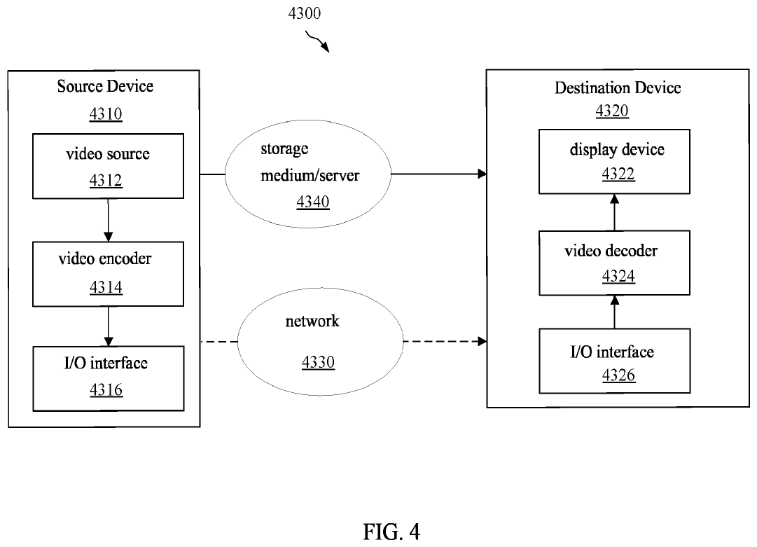

FIG. 4 is a block diagram that illustrates an example video coding system 4300 that may utilize the techniques of this disclosure. The video coding system 4300 may include a source device 4310 and a destination device 4320. Source device 4310 generates encoded video data which may be referred to as a video encoding device. Destination device 4320 may decode the encoded video data generated by source device 4310 which may be referred to as a video decoding device.

Source device 4310 may include a video source 4312, a video encoder 4314, and an input/output (I/O) interface 4316. Video source 4312 may include a source such as a video capture device, an interface to receive video data from a video content provider, and/or a computer graphics system for generating video data, or a combination of such sources. The video data may comprise one or more pictures. Video encoder 4314 encodes the video data from video source 4312 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. I/O interface 4316 may include a modulator/demodulator (modem) and/or a transmitter. The encoded video data may be transmitted directly to destination device 4320 via I/O interface 4316 through network 4330. The encoded video data may also be stored onto a storage medium/server 4340 for access by destination device 4320.

Destination device 4320 may include an I/O interface 4326, a video decoder 4324, and a display device 4322. I/O interface 4326 may include a receiver and/or a modem. I/O interface 4326 may acquire encoded video data from the source device 4310 or the storage medium/server 4340. Video decoder 4324 may decode the encoded video data. Display device 4322 may display the decoded video data to a user. Display device 4322 may be integrated with the destination device 4320, or may be external to destination device 4320, which can be configured to interface with an external display device.

Video encoder 4314 and video decoder 4324 may operate according to a video compression standard, such as the High Efficiency Video Coding (HEVC) standard, Versatile Video Coding (VVC) standard and other current and/or further standards.

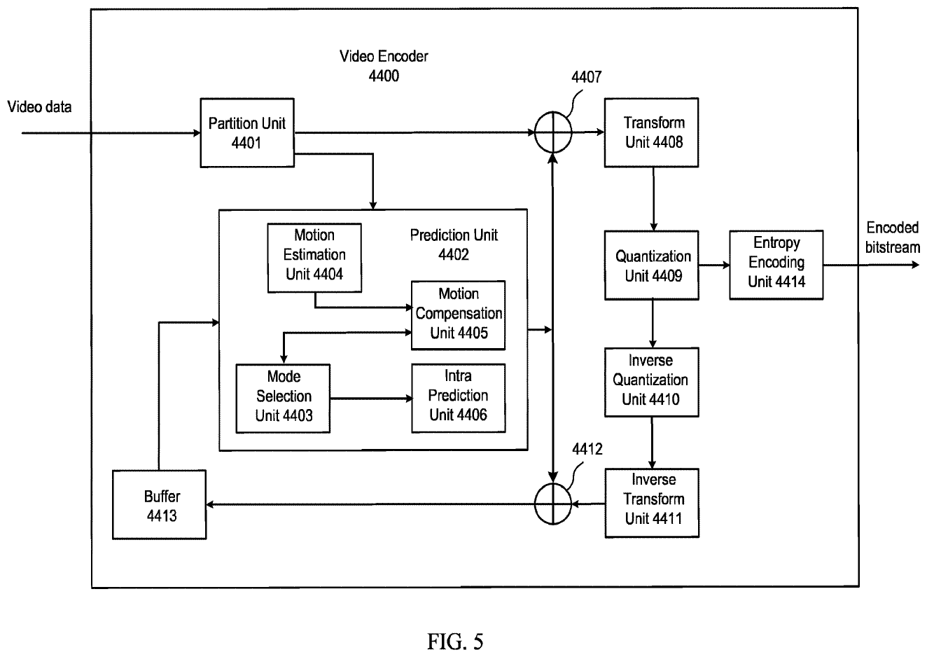

FIG. 5 is a block diagram illustrating an example of video encoder 4400, which may be video encoder 4314 in the system 4300 illustrated in FIG. 4. Video encoder 4400 may be configured to perform any or all of the techniques of this disclosure. The video encoder 4400 includes a plurality of functional components. The techniques described in this disclosure may be shared among the various components of video encoder 4400. In some examples, a processor may be configured to perform any or all of the techniques described in this disclosure.

The functional components of video encoder 4400 may include a partition unit 4401, a prediction unit 4402 which may include a mode select unit 4403, a motion estimation unit 4404, a motion compensation unit 4405, an intra prediction unit 4406, a residual generation unit 4407, a transform processing unit 4408, a quantization unit 4409, an inverse quantization unit 4410, an inverse transform unit 4411, a reconstruction unit 4412, a buffer 4413, and an entropy encoding unit 4414.

In other examples, video encoder 4400 may include more, fewer, or different functional components. In an example, prediction unit 4402 may include an intra block copy (IBC) unit. The IBC unit may perform prediction in an IBC mode in which at least one reference picture is a picture where the current video block is located.

Furthermore, some components, such as motion estimation unit 4404 and motion compensation unit 4405 may be highly integrated, but are represented in the example of video encoder 4400 separately for purposes of explanation.

Partition unit 4401 may partition a picture into one or more video blocks. Video encoder 4400 and video decoder 4500 may support various video block sizes.

Mode select unit 4403 may select one of the coding modes, intra or inter, e.g., based on error results, and provide the resulting intra or inter coded block to a residual generation unit 4407 to generate residual block data and to a reconstruction unit 4412 to reconstruct the encoded block for use as a reference picture. In some examples, mode select unit 4403 may select a combination of intra and inter prediction (CIIP) mode in which the prediction is based on an inter prediction signal and an intra prediction signal. Mode select unit 4403 may also select a resolution for a motion vector (e.g., a sub-pixel or integer pixel precision) for the block in the case of inter prediction.

To perform inter prediction on a current video block, motion estimation unit 4404 may generate motion information for the current video block by comparing one or more reference frames from buffer 4413 to the current video block. Motion compensation unit 4405 may determine a predicted video block for the current video block based on the motion information and decoded samples of pictures from buffer 4413 other than the picture associated with the current video block.

Motion estimation unit 4404 and motion compensation unit 4405 may perform different operations for a current video block, for example, depending on whether the current video block is in an I slice, a P slice, or a B slice.

In some examples, motion estimation unit 4404 may perform uni-directional prediction for the current video block, and motion estimation unit 4404 may search reference pictures of list 0 or list 1 for a reference video block for the current video block. Motion estimation unit 4404 may then generate a reference index that indicates the reference picture in list 0 or list 1 that contains the reference video block and a motion vector that indicates a spatial displacement between the current video block and the reference video block. Motion estimation unit 4404 may output the reference index, a prediction direction indicator, and the motion vector as the motion information of the current video block. Motion compensation unit 4405 may generate the predicted video block of the current block based on the reference video block indicated by the motion information of the current video block.

In other examples, motion estimation unit 4404 may perform bi-directional prediction for the current video block, motion estimation unit 4404 may search the reference pictures in list 0 for a reference video block for the current video block and may also search the reference pictures in list 1 for another reference video block for the current video block. Motion estimation unit 4404 may then generate reference indexes that indicate the reference pictures in list 0 and list 1 containing the reference video blocks and motion vectors that indicate spatial displacements between the reference video blocks and the current video block. Motion estimation unit 4404 may output the reference indexes and the motion vectors of the current video block as the motion information of the current video block. Motion compensation unit 4405 may generate the predicted video block of the current video block based on the reference video blocks indicated by the motion information of the current video block.

In some examples, motion estimation unit 4404 may output a full set of motion information for decoding processing of a decoder. In some examples, motion estimation unit 4404 may not output a full set of motion information for the current video. Rather, motion estimation unit 4404 may signal the motion information of the current video block with reference to the motion information of another video block. For example, motion estimation unit 4404 may determine that the motion information of the current video block is sufficiently similar to the motion information of a neighboring video block.

In one example, motion estimation unit 4404 may indicate, in a syntax structure associated with the current video block, a value that indicates to the video decoder 4500 that the current video block has the same motion information as another video block.

In another example, motion estimation unit 4404 may identify, in a syntax structure associated with the current video block, another video block and a motion vector difference (MVD). The motion vector difference indicates a difference between the motion vector of the current video block and the motion vector of the indicated video block. The video decoder 4500 may use the motion vector of the indicated video block and the motion vector difference to determine the motion vector of the current video block.

As discussed above, video encoder 4400 may predictively signal the motion vector. Two examples of predictive signaling techniques that may be implemented by video encoder 4400 include advanced motion vector prediction (AMVP) and merge mode signaling.

Intra prediction unit 4406 may perform intra prediction on the current video block. When intra prediction unit 4406 performs intra prediction on the current video block, intra prediction unit 4406 may generate prediction data for the current video block based on decoded samples of other video blocks in the same picture. The prediction data for the current video block may include a predicted video block and various syntax elements.

Residual generation unit 4407 may generate residual data for the current video block by subtracting the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and residual generation unit 4407 may not perform the subtracting operation.

Transform processing unit 4408 may generate one or more transform coefficient video blocks for the current video block by applying one or more transforms to a residual video block associated with the current video block.

After transform processing unit 4408 generates a transform coefficient video block associated with the current video block, quantization unit 4409 may quantize the transform coefficient video block associated with the current video block based on one or more quantization parameter (QP) values associated with the current video block.

Inverse quantization unit 4410 and inverse transform unit 4411 may apply inverse quantization and inverse transforms to the transform coefficient video block, respectively, to reconstruct a residual video block from the transform coefficient video block. Reconstruction unit 4412 may add the reconstructed residual video block to corresponding samples from one or more predicted video blocks generated by the prediction unit 4402 to produce a reconstructed video block associated with the current block for storage in the buffer 4413.

After reconstruction unit 4412 reconstructs the video block, the loop filtering operation may be performed to reduce video blocking artifacts in the video block.

Entropy encoding unit 4414 may receive data from other functional components of the video encoder 4400. When entropy encoding unit 4414 receives the data, entropy encoding unit 4414 may perform one or more entropy encoding operations to generate entropy encoded data and output a bitstream that includes the entropy encoded data.

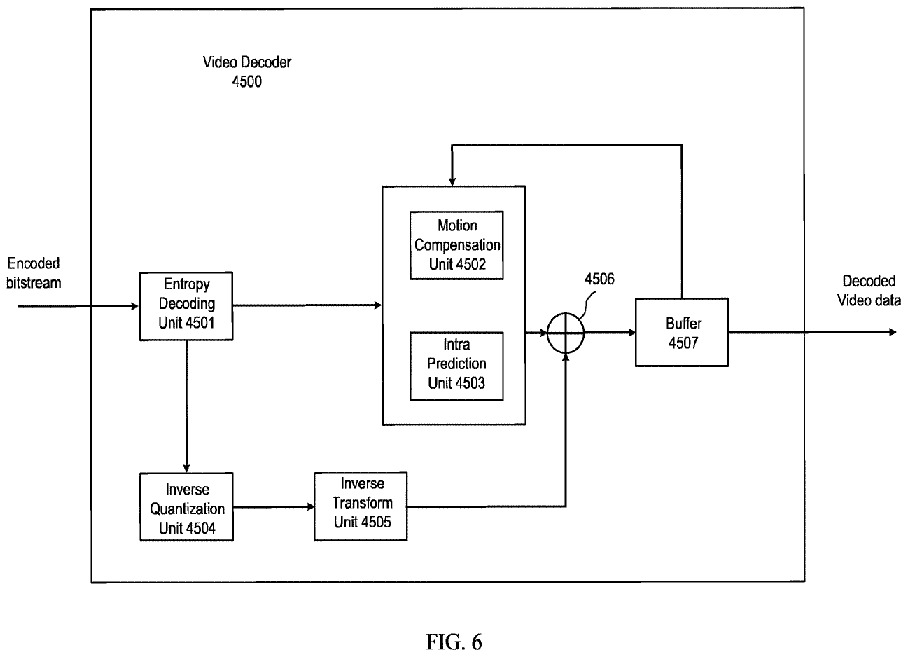

FIG. 6 is a block diagram illustrating an example of video decoder 4500 which may be video decoder 4324 in the system 4300 illustrated in FIG. 4. The video decoder 4500 may be configured to perform any or all of the techniques of this disclosure. In the example shown, the video decoder 4500 includes a plurality of functional components. The techniques described in this disclosure may be shared among the various components of the video decoder 4500. In some examples, a processor may be configured to perform any or all of the techniques described in this disclosure.

In the example shown, video decoder 4500 includes an entropy decoding unit 4501, a motion compensation unit 4502, an intra prediction unit 4503, an inverse quantization unit 4504, an inverse transformation unit 4505, a reconstruction unit 4506, and a buffer 4507. Video decoder 4500 may, in some examples, perform a decoding pass generally reciprocal to the encoding pass described with respect to video encoder 4400.

Entropy decoding unit 4501 may retrieve an encoded bitstream. The encoded bitstream may include entropy coded video data (e.g., encoded blocks of video data). Entropy decoding unit 4501 may decode the entropy coded video data, and from the entropy decoded video data, motion compensation unit 4502 may determine motion information including motion vectors, motion vector precision, reference picture list indexes, and other motion information. Motion compensation unit 4502 may, for example, determine such information by performing the AMVP and merge mode.

Motion compensation unit 4502 may produce motion compensated blocks, possibly performing interpolation based on interpolation filters. Identifiers for interpolation filters to be used with sub-pixel precision may be included in the syntax elements.

Motion compensation unit 4502 may use interpolation filters as used by video encoder 4400 during encoding of the video block to calculate interpolated values for sub-integer pixels of a reference block. Motion compensation unit 4502 may determine the interpolation filters used by video encoder 4400 according to received syntax information and use the interpolation filters to produce predictive blocks.

Motion compensation unit 4502 may use some of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter coded block, and other information to decode the encoded video sequence.

Intra prediction unit 4503 may use intra prediction modes for example received in the bitstream to form a prediction block from spatially adjacent blocks. Inverse quantization unit 4504 inverse quantizes, i.e., de-quantizes, the quantized video block coefficients provided in the bitstream and decoded by entropy decoding unit 4501. Inverse transform unit 4505 applies an inverse transform.

Reconstruction unit 4506 may sum the residual blocks with the corresponding prediction blocks generated by motion compensation unit 4502 or intra prediction unit 4503 to form decoded blocks. If desired, a deblocking filter may also be applied to filter the decoded blocks in order to remove blockiness artifacts. The decoded video blocks are then stored in buffer 4507, which provides reference blocks for subsequent motion compensation/intra prediction and also produces decoded video for presentation on a display device.

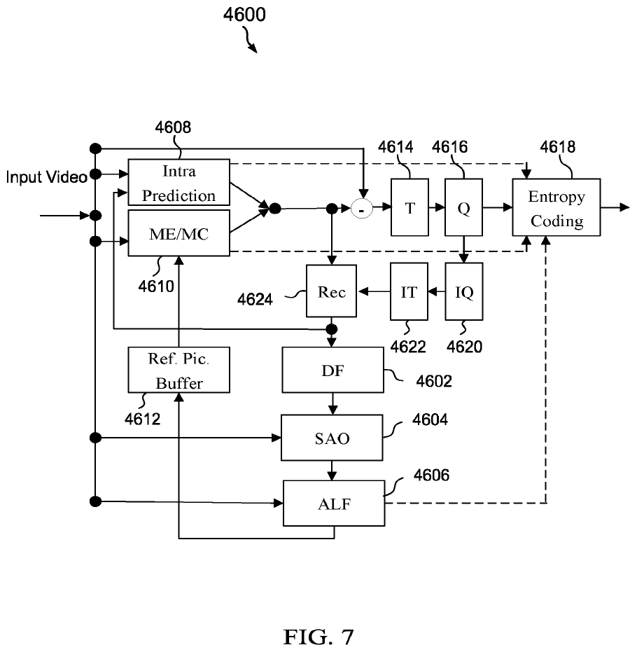

FIG. 7 is a schematic diagram of an example encoder 4600. The encoder 4600 is suitable for implementing the techniques of VVC. The encoder 4600 includes three in-loop filters, namely a deblocking filter (DF) 4602, a sample adaptive offset (SAO) 4604, and an adaptive loop filter (ALF) 4606. Unlike the DF 4602, which uses predefined filters, the SAO 4604 and the ALF 4606 utilize the original samples of the current picture to reduce the mean square errors between the original samples and the reconstructed samples by adding an offset and by applying a finite impulse response (FIR) filter, respectively, with coded side information signaling the offsets and filter coefficients. The ALF 4606 is located at the last processing stage of each picture and can be regarded as a tool trying to catch and fix artifacts created by the previous stages.

The encoder 4600 further includes an intra prediction component 4608 and a motion estimation/compensation (ME/MC) component 4610 configured to receive input video. The intra prediction component 4608 is configured to perform intra prediction, while the ME/MC component 4610 is configured to utilize reference pictures obtained from a reference picture buffer 4612 to perform inter prediction. Residual blocks from inter prediction or intra prediction are fed into a transform (T) component 4614 and a quantization (Q) component 4616 to generate quantized residual transform coefficients, which are fed into an entropy coding component 4618. The entropy coding component 4618 entropy codes the prediction results and the quantized transform coefficients and transmits the same toward a video decoder (not shown). Quantization components output from the quantization component 4616 may be fed into an inverse quantization (IQ) components 4620, an inverse transform component 4622, and a reconstruction (REC) component 4624. The REC component 4624 is able to output images to the DF 4602, the SAO 4604, and the ALF 4606 for filtering prior to those images being stored in the reference picture buffer 4612.

A listing of solutions preferred by some examples is provided next.

The following solutions show examples of techniques discussed herein.

1. A method for processing media data comprising: determining an identifying number or a syntax element named po_id is signalled in the SEI processing order SEI message to identify a group of SEI message types for which the preferred order of processing is indicated in the SEI processing order SEI message; and performing a conversion between a visual media data and a bitstream based on identifying number.

2. The method of clause 1, wherein it is specified that post-processing filter (PPF) may be indicated by an SEI message for which the payloadType value is in SeiProcessingOrderSeiList.

3. The method of any of clauses 1-2, wherein it is specified that, for each picture, there can be multiple PPFs activated and belonging to one or more PPF groups. PPF groups are alternative to each other, i.e., at most one group can be chosen to be applied.

4. The method of any of clauses 1-3, wherein a special PPF cascading case is defined as the case when such two PPFs are both activated for a picture: the two PPFs are both NNPFs (i.e., the payloadType value for the NNPFs indicates the neural-network post-filter characteristics SEI message), one of the two NNPFs has nnpfc_purpose equal to 4 and the other has multiple input pictures, and neither of the two NNPFs is associated with an SEI processing order SEI message. In this case, the two NNPFs are implicitly considered as belonging to one PPF group, and the NNPF with nnpfc_purpose equal to 4 is applied first.

5. The method of any of clauses 1-4, wherein other special PPF cascading cases may be defined.

6. The method of any of clauses 1-5, wherein how to handle those special cases (e.g., whether being in one PPF group, PPF processing order) are fixed without being indicated/signalled in the bitstream.

7. The method of any of clauses 1-6, wherein how to handle those special cases may still be indicated/signalled in the bitstream, but the indicated/signalled information are ignored and the pre-defined processing method is applied.

8. The method of any of clauses 1-7, wherein the order of applying PPFs in those special cases are predefined and it is a bitstream conformance requirement that the indicated order shall be identical the predefined order.

9. The method of any of clauses 1-8, wherein it is specified that, except for the special PPF cascading case, each PPF group containing multiple PPFs is associated with an SEI processing order SEI message with a particular value of a syntax element (e.g., named as po_id).

10. The method of any of clauses 1-9, wherein for all cases, each PPF group containing multiple PPFs is associated with an SEI processing order SEI message with a particular value of the syntax element (e.g., the po_id).

11. The method of any of clauses 1-10, wherein it is specified that, except for the special PPF cascading case, any PPF not associated with an SEI processing order SEI message is in its own PPF group.

12. The method of any of clauses 1-11, wherein for all cases, any PPF not associated with an SEI processing order SEI message is in its own PPF group.

13. The method of any of clauses 1-12, wherein it is specified that, one or more PPFs in the chosen PPF group can be applied. When multiple PPFs (in the chosen PPF group) are applied, they are applied in the cascading manner, meaning that they are applied in the order indicated by the SEI processing order SEI message associated with the chosen PPF group, and for each applied PPF that is not the last applied PPF, the output is used as the input of the next applied PPF.

14. The method of any of clauses 1-13, wherein it is specified that, one or more PPFs in the chosen PPF group can be applied. When multiple PPFs (in the chosen PPF group) are applied, they are applied in the cascading manner, meaning that they are applied in the order indicated by the SEI processing order SEI message associated with the chosen PPF group, and for each applied PPF that is not the last applied PPF, the output picture(s) are used as the input picture(s) of the next applied PPF.

15. The method of any of clauses 1-14, wherein it is constrained that colour transform information SEI messages associated with different SEI processing order SEI messages shall have different values of colour_transform_id.

16. The method of any of clauses 1-15, wherein the constraint is specified as follows: For any two SEI processing order SEI messages spoSeiA and spoSeiB present in a CVS, when spoSeiA contains an entry with po_sei_payload_type[i] equal to 142 (i.e., the payloadType of the colour transform information SEI message) and spoSeiB contains an entry with po_sei_payload_type[j] equal to 142, i and j may or may not be identical, po_sei_prefix_flag[i] in spoSeiA and po_sei_prefix_flag[j] spoSeiB shall both be equal to 1, and the value of the colour_transform_id syntax element contained in the SEI prefix indication of the i-th entry in spoSeiA shall not be equal to the value of the colour_transform_id syntax element contained in the SEI prefix indication of the j-th entry in spoSeiB. The same applies when po_sei_wrapping_flag[i] in spoSeiA or po_sei_wrapping_flag[j] in spoSeiB is equal to 1, in which case the colour_transform_id syntax element is directly included in the wrapped SEI message.

17. The method of any of clauses 1-16, wherein it is constrained that neural-network post-filter characteristics SEI messages associated with different SEI processing order SEI messages shall have different values of nnpfc_id.

18. The method of any of clauses 1-17, wherein the constraint is specified as follows: For any two SEI processing order SEI messages spoSeiA and spoSeiB present in a CVS, when spoSeiA contains an entry with po_sei_payload_type[i] equal to 210 (i.e., the payloadType of the neural-network post-filter characteristics SEI message) and spoSeiB contains an entry with po_sei_payload_type[j] equal to 210, i and j may or may not be identical, po_sei_prefix_flag[i] in spoSeiA and po_sei_prefix_flag[j] spoSeiB shall both be equal to 1, and the value of the nnpfc_id syntax element contained in the SEI prefix indication of the i-th entry in spoSeiA shall not be equal to the value of the nnpfc_id syntax element contained in the SEI prefix indication of the j-th entry in spoSeiB. The same applies when po_sei_wrapping_flag[i] in spoSeiA or po_sei_wrapping_flag[j] in spoSeiB is equal to 1, in which case the nnpfc_id syntax element is directly included in the wrapped SEI message.

19. The method of any of clauses 1-8, wherein the NNPFA SEI message is extended to be able to activate an NNPF for particular PPF group.

20. The method of any of clauses 19, wherein in a kind of NNPFA SEI extension, the po_id may be signalled as well for activating the NNPF of the particular PPF group with po_id.

21. The method of any of clauses 1-20, wherein a new activation SEI message is specified for non-NN PFFs.

22. The method of any of clauses 1-21, wherein in a kind of new activation SEI message, at least the id of the non-NN PFF may be signalled.

23. The method of any of clauses 1-22, wherein the non-PPF SEI messages themselves are extended to be able to activate a PPF for particular PPF group.

24. The method of any of clauses 1-23, wherein it is constrained that, within an SEI processing order SEI message, at most one of the SEI message types may indicate a post-processing filter that would interopolate pictures when applied.

25. The method of any of clauses 1-24, wherein it is constrained that, within an SEI processing order SEI message, only the last SEI message type may indicate a post-processing filter that would interopolate pictures when applied.

26. The method of any of clauses 1-25, wherein the preferred order of processing for the PPF that would interopolate pictures when applied is not explictily signalled, but inferred to be the indicted order of the second last PPF plus one.

27. The method of any of clauses 1-26, wherein a flag e.g. named po_last_ppf_picture_interpolation_flag is added outside of the loop of “for(i=0, i<po_num_sei_messages_minus2+2; i++)”, and po_sei_processing_order[i] is conditioned on “if((i<po_num_sei_messages_minus2+1)∥!po_last_ppf_picture_interpolation_flag)”, and the value of po_sei_processing_order[po_num_sei_messages_minus2+1] is inferred to be equal to po_sei_processing_order[po_num_sei_messages_minus2]+1.

28. The method of any of clauses 1-27, wherein the flag po_last_ppf_picture_interpolation_flag is not signalled, but a variable, e.g., named PoLastPpfPictureInterpolationFlag, is derived according to the SEI payloadType and, if present, the SEI prefix indication of the last entry, which indicates whether the last PPF would interpolate picture when applied, and po_sei_processing_order[i] is conditioned on “if ((i<po_num_sei_messages_minus2+1)! PoLastPpfPictureInterpolationFlag)”, and the value of po_sei_processing_order[po_num_sei_messages_minus2+1] is inferred to be equal to po_sei_processing_order[po_num_sei_messages_minus2]+1.

29. The method of any of clauses 1-28, wherein the syntax element po_num_prefix_bytes[i] is changed to be po_num_prefix_bytes_minus1 [i], i.e. signalling the number of prefix bytes minus 1 instead of signalling the number of prefix bytes.

30. The method of any of clauses 1-29, wherein the syntax element po_num_prefix_bytes[i] is kept unchanged, the po_sei_prefix_flag is removed and whether prefix is available is depending on whether po_num_prefix_bytes[i] is zero.

31. An apparatus for processing video data comprising: a processor; and a non-transitory memory with instructions thereon, wherein the instructions upon execution by the processor, cause the processor to perform the method of any of clauses 1-30.

32. A non-transitory computer readable medium comprising a computer program product for use by a video coding device, the computer program product comprising computer executable instructions stored on the non-transitory computer readable medium such that when executed by a processor cause the video coding device to perform the method of any of clauses 1-30.

33. A non-transitory computer-readable recording medium storing a bitstream of a video which is generated by a method performed by a video processing apparatus, wherein the method comprises: determining an identifying number or a syntax element named po_id is signalled in the SEI processing order SEI message to identify a group of SEI message types for which the preferred order of processing is indicated in the SEI processing order SEI message; and generating a bitstream based on the determining.

34. A method for storing bitstream of a video comprising: determining an identifying number or a syntax element named po_id is signalled in the SEI processing order SEI message to identify a group of SEI message types for which the preferred order of processing is indicated in the SEI processing order SEI message; generating a bitstream based on the determining; and storing the bitstream in a non-transitory computer-readable recording medium.

35. A method, apparatus, or system described in the present disclosure.

In the solutions described herein, an encoder may conform to the format rule by producing a coded representation according to the format rule. In the solutions described herein, a decoder may use the format rule to parse syntax elements in the coded representation with the knowledge of presence and absence of syntax elements according to the format rule to produce decoded video.

In the present disclosure, the term “video processing” may refer to video encoding, video decoding, video compression or video decompression. For example, video compression algorithms may be applied during conversion from pixel representation of a video to a corresponding bitstream representation or vice versa. The bitstream representation of a current video block may, for example, correspond to bits that are either co-located or spread in different places within the bitstream, as is defined by the syntax. For example, a macroblock may be encoded in terms of transformed and coded error residual values and also using bits in headers and other fields in the bitstream. Furthermore, during conversion, a decoder may parse a bitstream with the knowledge that some fields may be present, or absent, based on the determination, as is described in the above solutions. Similarly, an encoder may determine that certain syntax fields are or are not to be included and generate the coded representation accordingly by including or excluding the syntax fields from the coded representation.

The disclosed and other solutions, examples, embodiments, modules and the functional operations described in this disclosure can be implemented in digital electronic circuitry, or in computer software, firmware, or hardware, including the structures disclosed in this disclosure and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform functions by operating on input data and generating output. The processes and logic flows can also be performed by, and apparatus can also be implemented as, special purpose logic circuitry, e.g., a field programmable gate array (FPGA) or an application specific integrated circuit (ASIC).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., erasable programmable read-only memory (EPROM), electrically erasable programmable read-only memory (EEPROM), and flash memory devices; magnetic disks, e.g., internal hard disks or removable disks; magneto optical disks; and compact disc read-only memory (CD ROM) and Digital versatile disc-read only memory (DVD-ROM) disks. The processor and the memory can be supplemented by, or incorporated in, special purpose logic circuitry.

While the present disclosure contains many specifics, these should not be construed as limitations on the scope of any subject matter or of what may be claimed, but rather as descriptions of features that may be specific to particular embodiments of particular techniques. Certain features that are described in the present disclosure in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in the present disclosure should not be understood as requiring such separation in all embodiments.

Only a few implementations and examples are described and other implementations, enhancements and variations can be made based on what is described and illustrated in the present disclosure.

A first component is directly coupled to a second component when there are no intervening components, except for a line, a trace, or another medium between the first component and the second component. The first component is indirectly coupled to the second component when there are intervening components other than a line, a trace, or another medium between the first component and the second component. The term “coupled” and its variants include both directly coupled and indirectly coupled. The use of the term “about” means a range including ±10% of the subsequent number unless otherwise stated.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled may be directly connected or may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method for processing media data, comprising:
performing a conversion between a visual media data and a bitstream according to a rule,
wherein the rule specifies that, except for one or more special post-processing filter (PPF) cascading cases, each processing chain containing multiple supplemental enhancement information (SEI) message types is indicated by an SEI processing order (SPO) SEI message with a particular value of a processing order identifier syntax element.

2. The method of claim 1, wherein the SPO SEI message carries information indicating a preferred processing order for a group of types of SEI messages that is allowed to be present in a coded video sequence (CVS).

3. The method of claim 2, wherein the preferred processing order for the group of types of SEI messages is in a list of SEI payload types.

4. The method of claim 3, wherein an SEI message having a payload type in the list of SEI payload types indicates a post-processing filter (PPF).

5. The method of claim 4, wherein except for the one or more special PPF cascading cases, any post-processing filter (PPF) not indicated by an SPO SEI message is in its own processing chain.

6. The method of claim 3, wherein the list of SEI payload types comprises a list of SEI payload types each implying a post-processing process.

7. The method of claim 1, wherein multiple post processing filters (PPFs) are activated for at least one picture.

8. The method of claim 7, wherein the multiple PPFs belong to one or more processing chains.

9. The method of claim 8, wherein the one or more processing chains are alternative to each other.

10. The method of claim 8, wherein at most one of the one or more processing chains is allowed to be chosen to be applied by a decoding apparatus at one time.

11. The method of claim 1, wherein the one or more special PPF cascading cases include a special NNPF cascading case, which is defined as a case when two PPFs are both activated for a picture: the two PPFs are both NNPFs, one of the two NNPFs has nnpfc_purpose equal to 4 and the other has multiple input pictures, and neither of the two NNPFs is associated with the SPO SEI message.

12. The method of claim 11, wherein the two NNPFs are implicitly considered as belonging to one processing chain, and wherein the NNPF with nnpfc_purpose equal to 4 is applied first.

13. The method of claim 1, wherein the conversion includes encoding the visual media data into the bitstream.

14. The method of claim 1, wherein the conversion includes decoding the visual media data from the bitstream.

15. An apparatus for processing video data, comprising:
a processor; and
a non-transitory memory with instructions thereon, wherein the instructions upon execution by the processor, cause the processor to:
perform a conversion between a visual media data and a bitstream according to a rule,
wherein the rule specifies that, except for one or more special post-processing filter (PPF) cascading cases, each processing chain containing multiple supplemental enhancement information (SEI) message types is indicated by an SEI processing order (SPO) SEI message with a particular value of a processing order identifier syntax element.

16. The apparatus of claim 15, wherein the SPO SEI message carries information indicating a preferred processing order for a group of types of SEI messages that is present in a coded video sequence (CVS).

17. The apparatus of claim 15, wherein the preferred processing order for the group of types of SEI messages is in a list of SEI payload types.

18. The apparatus of claim 15, wherein an SEI message having a payload type in the list of SEI payload types indicates a post-processing filter (PPF).

19. A non-transitory computer readable storage medium storing instructions that cause a processor to:
perform a conversion between a visual media data and a bitstream according to a rule,
wherein the rule specifies that, except for one or more special post-processing filter (PPF) cascading cases, each processing chain containing multiple supplemental enhancement information (SEI) message types is indicated by an SEI processing order (SPO) SEI message with a particular value of a processing order identifier syntax element.

20. A non-transitory computer-readable recording medium storing a bitstream of a video which is generated by a method performed by a video processing apparatus, wherein the method comprises:
generating the bitstream according to a rule,
wherein the rule specifies that, except for a special neural network post filter (NNPF) cascading case, each processing chain containing multiple supplemental enhancement information (SEI) message types is indicated by an SEI processing order (SPO) SEI message with a particular value of a processing order identifier syntax element.
